(19) United States
(12) Patent Application Publication
(10) Pub. No.: US 2004/0010886 A1
(43) Pub. Date: Jan. 22, 2004

(54) Door holder

(76) Inventor: Stefan Eldh, Orsa (SE)

Correspondence Address: JACOBSON HOLMAN PLLC, 400 SEVENTH STREET N.W., SUITE 600, WASHINGTON, DC, 20004, US

(21) Appl. No.: 10/239,880

(22) PCT Filed: Mar. 8, 2001
(86) PCT No.: PCT/SE01/00490

(30) Foreign Application Priority Data
Apr. 13, 2000 (SE) 0001374-8

(51) Int. Cl. E05F 3/00

(52) U.S. Cl. 16/49

(57) ABSTRACT

A door holder includes a rail (1) which has a longitudinally extending slot (10) for movement of a slide body (11) relative to the rail. The slide body is pivotally connected to one end (21) of a holder rod (2), the other end (22) of which is pivotally fastened to a door frame. As the door is opened and closed, the slide body (11) is moved from a first position (a), in which the door is closed, to a second position (b), in which the door is open, or vice versa. In the second position (b), the rail (1) provides a narrower free passage for the slide body (11) than at the first position (a) so that as the door opens the side body (11) will slide easily in the rail (1) until it reaches said second position (b), at which the door is braked as a result of the narrower free passage provided by the rail, while successively increasing resistance to movement of the slide body (11) in the rail (1).

### FIELD OF INVENTION

The present invention relates to a door holder of the kind defined in the preamble of claim 1.

The invention thus relates to a door holder of the kind that shall be fitted to the inside of an outwardly opening door, e.g. a garage door, and that includes a longitudinally slotted rail or bar which can be attached horizontally to the door adjacent its upper edge and which is intended for co-action with a slide body that is movable relative to the rail and that can be pivotally connected to one end of a holder rod whose other end is pivotally attached to an upper horizontal part of the door frame.

### DESCRIPTION OF THE BACKGROUND ART

A door holder of this kind is described in Swedish Patent Specification 464144. Although this door holder functions satisfactorily per se, it includes several components, e.g. a latching mechanism with latching devices, an abutment element that includes two abutment portions, pivot pins, springs, etc., which make it desirable to simplify the construction to some degree, i.e. by reducing the number of components and lowering manufacturing costs.

A door holder that retards the opening movement of a door is known from GB 1294389.

Although the risk of damage to the door, the door frame, the door holder and the door suspension is reduced by allowing the door holder to brake the door during essentially the whole of its opening movement, this retardation of door movement should be relatively weak so as to enable a weak user to open the door relatively easily, in which case the risk of damage is relatively great when the door is opened rapidly by a strong person such that the door will have a relatively high kinetic energy as the door holder reaches its end position.

### DISCLOSURE OF THE INVENTION

Accordingly, one object of the invention is to provide a door holder in which said drawback is eliminated either completely or partially.

The invention is defined in the accompanying independent claim.

Further embodiments of the door holder will be apparent from the accompanying dependent claims.

### DESCRIPTION OF A PREFERRED EMBODIMENT

The invention will now be described in more detail with reference to the accompanying drawing, in which

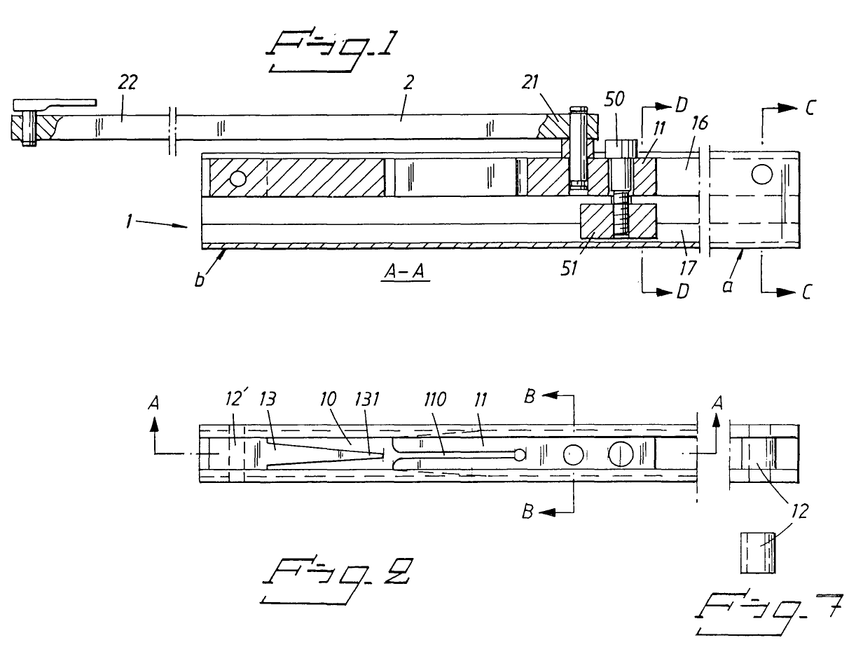

FIG. 1 is a partially sectioned side view A-A of a rail or bar 1 that includes a longitudinally extending slot;

FIG. 2 shows the rail of FIG. 1 from above;

FIG. 3 is a sectional side view B-B of the rail shown in FIGS. 1-2;

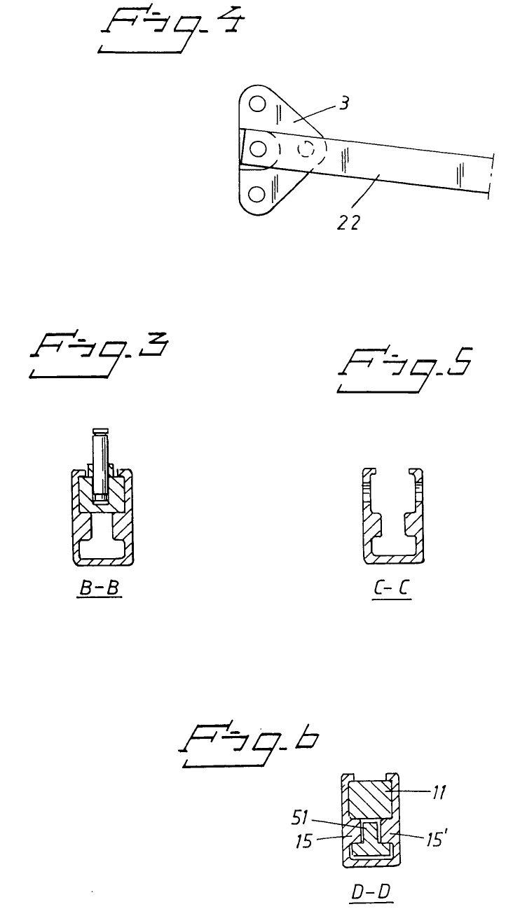

FIG. 4 shows from beneath the end 22 of a holder rod 2 according to FIG. 1, and an attachment 3 for one end 22 of the rod;

FIG. 5 is a sectioned side view C-C of the rail shown in FIGS. 1-2;

FIG. 6 is a sectioned side view D-D of the rail shown in FIGS. 1-2; and

FIG. 7 shows a rail spacer element 12.

The longitudinally extending slot 10 in the rail 1 is intended to accommodate a slide body 11 which is displaceable relative to the rail and which is pivotally connected to one end 21 of a holder rod 2 whose other end 21 can be hinged to an upper horizontal part of the frame of a garage door. Provided at the right-hand end a of the rail 1 is a spacer element 12 which functions, at the same time, as fastener means for a screw or equivalent fastener for fastening the rail 1 to the door. A similar spacer element 12′ is provided at the other (the left) end b of the rail.

As the door is opened and closed, the holder rod 2 is moved in a horizontal plane while, at the same time, moving the slide body 11 from a first position a, in which the door is closed, to a second position b in which the door is open.

The free passage area provided for the slide body 11 by the rail 1 in said second (left) position b is smaller than at the first (right) position a, thereby stopping opening movement of the door and holding the door in a fully open position. This door retaining or holding function can be achieved in several different ways.

One way is illustrated in FIG. 2. A wedging body 13 is placed in the left end of the rail 1. The slide body 11 has a narrow opening 110 that corresponds to the wedge part of the wedging body 13. In the final stage of the door opening function, the slide body 11 is pressed onto the wedging body 13 and the door remains open until it is forcibly closed. (The left part (12′) of the wedging body 13 also will suitably have the same function as the spacer element 12, namely the function of a spacer element).

Another way of achieving this retaining or holding function is to provide at position b on the rail 1 a spacer element 12′ similar to that at position a but slightly shorter, therewith causing the legs of the U-shaped slide rail 1 to be pressed together slightly more at b than at a, thereby successively decreasing the free passage area somewhat to the left.

The use of a screw device and a spacer element 12 at position a that is 12.5 mm long, and a distance element 12′ at position b that is 11.5 mm long, will cause movement of the door to be stopped at position b and the door held in this open position, when opening the door.

In order to provide the door with an adjustable resistance to movement when opening/closing the door, the slide body 11 placed in the upper part 16 of the rail 1 is connected at its under-part 17 to a brake block 51 via a screw fastener 15, as shown in FIGS. 1 and 6. When the screw fastener 50 is tightened, the pressure exerted by the slide body 11 and the brake block 51 against two projections 15, 15′ on the rail 1 will increase (increased resistance), and will decrease (reduced resistance) when the screw fastener is loosened.

1. A door holder intended to be fitted to the inside of an outwardly opening door and comprising a rail (1) which includes a longitudinally extending slot and which can be affixed horizontally to the upper edge of said door, wherein the rail (1) is intended to accommodate a slide body (11) which can be moved relative to the rail (1) and which is pivotably connected to one end (21) of a holder rod (2) whose other end (22) is intended be hinged to an upper horizontal part of the door frame, wherein as the door is opened and closed, the slide body moves from a first position (a), in which the door is closed, to a second position (b) in which the door is opened, wherein the rail (1) provides a smaller free passage area for the slide body (11) at said second position (b) than at said first position (a), such that as the door is opened the slide body (11) will slide freely in the rail (1) until it reaches said second position (b) at which the door is stopped as a result of the smaller free passage area of the rail during successive increase in the resistance to movement of the slide body (11) in the rail (1), characterised in that the rail (1) includes at said second position (b) a conical body (13) located in the longitudinal slot (10) in the rail (1) with the apex (131) of said conical body (13) facing out in the longitudinal direction of the slot; and in that the slide body (11) has a narrow central opening (110) which faces towards and corresponds to the pointed part (131) of the conical body (13).

2. A door holder according to claim 1, characterised in that the rail (1) is U-shaped and has a spacer element (12) at said first position (a) between the two legs of the rail (1), said spacer element also functioning as fastener means for a screw or like device for fastening the rail (1) to the door.

3. A door holder according to claim 1 or 2, characterised in that a brake block (51) is provided in the rail (1) and supported by the slide body (11) via a screw device (5), wherein the rail has projections (15, 15′) that extend along the rail between the brake block (51) and the slide body (11), and wherein the screw device (5) can be adapted to give the slide body (11) and the brake block (5) a chosen force of abutment with the projections and therewith a chosen constant resistance to movement along the rail. (5) a chosen force of abutment with the projections and therewith a chosen constant resistance to movement along the rail.
